(19) United States
(12) Patent Application Publication
(10) Pub. No.: US 2025/0268238 A1
(43) Pub. Date: Aug. 28, 2025

(54) HUMMINGBIRD SHOOTING SYSTEM

(71) Applicant: Netvue Technologies Co., Ltd., Shenzhen (CN)

(72) Inventor: Chuan Chen, Shenzhen (CN)

(21) Appl. No.: 19/053,444

(22) Filed: Feb. 14, 2025

Related U.S. Application Data
(63) Continuation-in-part of application No. 18/788,338, filed on Jul. 30, 2024.

(30) Foreign Application Priority Data
Feb. 28, 2024 (CN) 202410222791.6
Feb. 28, 2024 (CN) 202420375223.5

(51) Int. Cl. A01K 39/02; A01K 29/00

(52) U.S. Cl. CPC A01K 39/0206; A01K 29/005

(57) ABSTRACT

A hummingbird shooting system includes a feeding assembly and a camera, the feeding assembly including an suck component and an extension component, the suck component being used for suck of a hummingbird, the extension component being connected to the suck component, and the extension component being used for extending the suck component to a designated shooting position opposite to the camera for the camera to capture an image of the hummingbird in a pre-set area according to shooting requirements when the hummingbird is taking sugar water; where the image of the hummingbird includes: at least one of the hummingbird, the suck component, and the extension component. The hummingbird shooting system designed in the present application may shoot an image of the hummingbird by simulating a real scene where the hummingbird takes the sugar water in nature when it is taking the sugar water.

### CROSS-REFERENCE TO RELATED APPLICATIONS

This application is a continuation in part application of U.S. patent application Ser. No. 18/788,338, filed on Jul. 30, 2024, which claims priorities to Chinese Patent Application No. 202410222791.6, filed on Feb. 28, 2024, Chinese Patent Application No. 202420375223.5, filed on Feb. 28, 2024, the contents of which are incorporated herein by reference in its entirety.

### TECHNICAL FIELD

The present application relates to the technical field of bird activity shooting, and particularly to a hummingbird shooting system.

### BACKGROUND

In recent years, with the improvement of material living standard, more and more people living in the area where the hummingbirds live have tried to attract and observe the hummingbirds by using a hummingbird water feeder; the hummingbirds take liquid nectar for food, and therefore the hummingbird water feeder is often provided with sugar water to simulate nectar and facilitate the hummingbirds to take the sugar water with their slender beaks.

It is found from study that when human beings are in the vicinity of the hummingbird water feeder for observation, the hummingbird usually will not go to the hummingbird water feeder to suck sugar water because of biological vigilance, which brings great difficulty to the user's observation behavior, and it is inconvenient to observe hummingbird's activity of taking the sugar water.

Therefore, it is urgently needed to design a new hummingbird shooting system to replace the manual shooting and recording when the hummingbird sucks the sugar water, so as to make it convenient for the user to view and study the hummingbird, and to ensure that there is no other structure in the captured image of the hummingbird other than the feeding assembly and the hummingbird, thus perfectly simulating a real scene where the hummingbird sucks nectar in nature.

### SUMMARY

A technical problem to be solved by the present application is that the present application discloses a hummingbird shooting system to replace manual shooting and recording of a process in which a hummingbird takes the sugar water, and ensure that there is no other structure in the captured image of the hummingbird other than the feeding assembly and the hummingbird, which perfectly simulates a real scene where the hummingbird sucks nectar in nature.

In order to solve the above technical problem, the technical solution adopted by the present application is a hummingbird shooting system including a feeding assembly and a camera, the feeding assembly including an suck component and an extension component, the suck component being used for suck of a hummingbird, the extension component being connected to the suck component, and the extension component being used for extending the suck component to a designated shooting position opposite to the camera for the camera to capture an image of the hummingbird in a pre-set area according to shooting requirements when the hummingbird is taking sugar water; where the image of the hummingbird includes at least one of the hummingbird, the suck component, and the extension component.

For the problem in the prior art that it is difficult to artificially observe a hummingbird taking sugar water, in the above-mentioned technical solution of the present application, the present application discloses a new hummingbird shooting system, where an suck component of the hummingbird shooting system may be provided with sugar water for the hummingbird to take, and the suck component may be sent to a designated shooting position opposite to a camera by an extension component so as to facilitate the camera to capture an image of the hummingbird in a pre-set area when the hummingbird is taking the sugar water, and the image of the hummingbird includes at least one of the hummingbird, the suck component, and the extension component.

Thus, the hummingbird shooting system of the present application may replace the manual shooting and recording when the hummingbird sucks the sugar water, so as to facilitate a user to study the hummingbird suck process and habit, and ensure that there is no other structure in the captured image of the hummingbird other than the feeding assembly and the hummingbird, thus perfectly simulating a real scene where the hummingbird sucks nectar in nature, and the system has a good promotion prospect and application value.

Further, in the hummingbird shooting system described in the present application, the image of the hummingbird includes a hummingbird but excludes the suck component and the extension component;
or the image of the hummingbird includes at least part of the suck component and the hummingbird but excludes the extension component;
or the image of the hummingbird includes at least part of the suck component, at least part of the extension component and the hummingbird.

In the above-mentioned technical solution of the present application, in practice, in order to obtain a better shooting effect, when the above-mentioned suck component and the camera are mounted and provided, it may be controlled that the image of the hummingbird in a pre-set area captured by the camera includes hummingbirds, rather than the suck component and the extension component in the feeding assembly, so as to maximally simulate the real scene where the hummingbird sucks nectar in nature.

It is obvious that in some embodiments, in order to improve the aesthetics of the image of the hummingbird, so that a user may obtain a more aesthetic image when observing the image of the hummingbird, in practice, the simulated appearance of the above-mentioned suck component and the extension component may be adaptively adjusted so as to be more in line with a state of plants in nature.

At this time, when the hummingbird taking the sugar water is shot, it is preferable to control the image of the hummingbird to include a hummingbird and at least part of the suck component; or the image of the hummingbird includes a hummingbird, at least a portion of the suck component, and at least a portion of the extension component, thereby ensuring that the image of the hummingbird conforms more to the natural scene.

Further, in the hummingbird shooting system described in the present application, the suck component is provided with at least one suck port for the hummingbird's suck of the sugar water through the suck port;
the suck component is provided with a water storing bladder, and the suck port communicates with the water storing bladder;
the water storing bladder independently stores water;
or the water storing bladder is connected to a water tank, and the water tank supplies the sugar water.

In the above-mentioned technical solution of the present application, the above-mentioned suck component is provided with a water storing bladder and an suck port communicating with the water storing bladder, so that the hummingbird protrudes its slender beak into the above-mentioned water storing bladder through the suck port to suck the sugar water; in practice, the above-mentioned water storing bladder may store water independently or may be connected to an external water tank, and the water tank supplies the sugar water, which does not affect the image capturing of a process in which the hummingbird takes the sugar water.

It should be noted that, in consideration of a leakproofness problem, if the leakproofness of an suck port of an suck component is poor, it is easy to cause deterioration of sugar and water, and it is easy to cause ants and bees to fight for the sugar water; in practice, a duckbill valve may also be provided at the above-mentioned suck port, where the duckbill valve is tightly closed in a conventional state and may be easily extended through and opened by the beak of the hummingbird, so as to prevent ants and bees as well as prevent deterioration of the sugar water and provide the sugar water for the hummingbird. In order to obtain a better implementation effect, in practice, the above-mentioned duckbill valve and the suck port may both be specifically prepared from a flexible material, so as to avoid the hummingbird being injured when it is taking the sugar water due to excessive rigidity of the material.

Further, in the hummingbird shooting system described in the present application, the suck component further includes a flower simulating component, and the flower simulating component is connected to an edge of the suck port.

In the above-mentioned technical solution of the present application, in order to improve the simulation of the above-mentioned suck component, effectively attract the hummingbird for suck, and improve the aesthetic effect of the image of the hummingbird captured by the camera, and to restore to the maximum extent the real scene where the hummingbird sucks nectar in nature, the suck component used in the present application may also specifically adopt a simulation design, so as to attract the hummingbird based on connecting the flower simulating component at an edge of the suck port.

It should be noted that, in practice, in order to facilitate preparation, the above-mentioned flower simulating component may be an integral extension of the above-mentioned suck port, so as to make the integrity stronger; it is obvious that the above-mentioned flower simulating component may also be detachably connected to an edge of the suck port of the above-mentioned suck component in consideration of the damage and aging problems that may exist in nature, thereby facilitating the user to detach and replace a new flower simulating component. Further, in the hummingbird shooting system described in the present application, the extension component has one end connected to the suck component and has the other end connected to the ground or another mounting position.

In the above-mentioned technical solution of the present application, the mounting position of the extension component of the hummingbird shooting system may be various, which may be adjusted according to the specific application environment, and the extension component may be used to adjust the relative position of the above-mentioned suck component and the camera.

In practice, the above-mentioned extension component may have one end connected to the suck component and has the other end connected to the ground or another mounting position so as to support the suck component; for example, in some embodiments, the other end of the extension component may be connected to a tree, a wall, or a peg, and the user may adjust the form and position of the extension component and the suck component as desired.

Further, in the hummingbird shooting system described in the present application, the extension component has one end connected to the suck component and the other end connected to the body; where the other end of the extension component is connected to at least one of a top end, a bottom end and a middle portion of the body.

Further, in the hummingbird shooting system described in the present application, the camera is provided on or around the body.

In the above-mentioned technical solution of the present application, in order to facilitate mounting of various components of the hummingbird shooting system, in practice, one body may also be provided, where appearance of the body is unlimited, and the body may be used for connecting an extension component so as to make the mounting position of the extension component more secure and reliable, so as to reduce the adverse interference of the adverse natural environment on the extension component and the suck component of the feeding assembly.

Accordingly, in practice, the above-mentioned camera may be specifically provided on the body, and an image of the hummingbird in a pre-set area is captured according to shooting requirements when the hummingbird is taking sugar water; it is obvious that in some embodiments, it is also possible to use a split-type design, i.e., the camera is not provided on the body, but is provided around the body and takes a picture of the suck component connected to one end of the extension component connected to the body.

Further, in the hummingbird shooting system described in the present application, the body is provided with a water tank, and the extension component is provided with a water delivering passage;
the water delivering passage communicates with the water tank and the suck component; or the suck component is provided with a water storing bladder, and the water delivering passage communicates with the water tank and the water storing bladder.

In the above-mentioned technical solution of the present application, in consideration of an outdoor environment, a user may need to be able to supplement the sugar water once at a long time interval; therefore, in practice, it is also possible to provide a water tank holding the sugar water on the body, and control the above-mentioned extension component to be provided with a water delivering passage so as to communicate the water tank and the suck component with the water delivering passage, thereby facilitating the flow of the sugar water stored in the water tank from the water delivering passage to the suck component, and ensuring timely supplement when there is shortage of the sugar water in the suck component.

It is obvious that in practice, the suck component may also be provided with a certain independent water storing capability, i.e., the suck component may be provided with an independent water storing bladder, so that the above-mentioned water delivering passage may communicate the water tank and the water storing bladder, and may deliver the sugar water in the water tank to the water storing bladder for storage, so as to facilitate a hummingbird to extend its beak into the water storing bladder for suck of the sugar water, so as to facilitate shooting a process in which the hummingbird takes the sugar water.

Further, in the hummingbird shooting system described in the present application, the other end of the extension component is connected to the top end of the body, the water delivering passage communicates with the water tank from the top end of the body, and the water tank supplies the sugar water to the water delivering passage from the top end of the body.

In the above-mentioned technical solution of the present application, in order to further optimize the process of supplementing sugar water in the water storing bladder of the above-mentioned suck component, in practice, according to the connection of the other end of the extension component with different positions of the body, a plurality of sugar water driving forms may be used to deliver the sugar water in the water tank to the water delivering passage.

For example, in some embodiments, it is possible to control the other end of the extension component to be connected to the top end of the body, so that the water delivering passage communicates with the water tank from the top end of the body, and at this time, since the level of the sugar water in the water tank is lower than the height of the above-mentioned water delivering passage, the communicating vessel principle cannot be used for unpowered feeding of the sugar water in the water tank into the water storing bladder of the suck component.

For this reason, under this connection condition, the user may send the sugar water in the water tank from the water delivering passage into the water storing bladder of the suck component in an electric drive mode (electric drive) or a negative pressure siphon mode (atmospheric pressure power); in practice, a suitable driving form may be selected according to specific application requirements.

For another example, in other embodiments, the other end of the extension component may be controlled to be connected to the middle portion or the bottom end of the body, so that the water delivering passage communicates with the water tank from the middle portion or the bottom end of the body, so as to realize unpowered feeding of the sugar water in the water tank into the water storing bladder of the suck component based on the communicating vessel principle; it is obvious that it is also possible to supply the sugar water in the water tank to the water delivering passage in the form of electric drive.

Further, in the hummingbird shooting system described in the present application, the body siphons the sugar water in the water tank to the suck component through the water delivering passage.

Further, in the hummingbird shooting system described in the present application, the body includes a lower housing and an upper cover body, the upper cover body and the lower housing together forming a water storing chamber of the water tank; when a downward pressure is applied to the upper cover body, the upper cover body is pressed and sealedly cooperates the lower housing and compresses the water storing chamber space to achieve siphoning.

Further, in the hummingbird shooting system described in the present application, the upper cover body includes an outer cover body, an inner cover body and an air chamber tube, where the outer cover body is rotatably covered on the top end of the inner cover body, the top end of the air chamber tube is connected to the inner cover body, and the bottom end may be placed inside the water storing chamber; the other end of the extension component passes through the upper cover body from the top end of the body, extends into the air chamber tube and extends out of the bottom end of the air chamber tube; a venting passage is provided in the upper cover body and used for communicating the air chamber tube with the outside, and the venting passage is closed when the outer cover body is in the first position; the venting passage is conductive when the outer cover body rotates relative to the inner cover body and is in the second position.

Further, in the hummingbird shooting system described in the present application, the outer cover body is rotatably covered on the top end of the inner cover body and detachably assembled with the lower housing, and the top end periphery of the inner cover body is sealedly assembled with the lower housing.

Further, in the hummingbird shooting system described in the present application, a communication hole is provided at the top of the inner cover body, the communication hole correspondingly communicates with the air chamber tube, and a sealing gasket is provided on a peripheral wall of the communication hole; one end of the outer cover body corresponding to the inner cover body is provided with an annular protrusion, and the annular protrusion is provided corresponding to the communication hole and is sealable by the sealing gasket when the outer cover body is in the first position.

Further, in the hummingbird shooting system described in the present application, an internal venting port is provided on the annular protrusion, an external venting port is provided on an outer wall of the outer cover body, and a conduction passage between the external venting port and the internal venting port is the venting passage; when the outer cover body is in the first position, the sealing gasket seals the internal venting port, the external venting port, the internal venting port and the communication hole are non-conductive, and when the outer cover body rotates to a second position, the sealing gasket does not seal the internal venting port, and the external venting port, the internal venting port and the communication hole are conductive.

Further, in the hummingbird shooting system described in the present application, the sealing gasket is provided with a recessed portion, and a thickness of a gasket of the recessed portion is smaller than a thickness of a respective gasket of other parts; when the outer cover body is in the first position, the internal venting port is sealed by other parts of the sealing gasket, and when the outer cover body rotates to the second position, the internal venting port correspondingly rotates to the recessed portion, and the internal venting port is conductive to the communication hole.

Further, in the hummingbird shooting system described in the present application, when the upper cover body is in the second position, a port at which the extension component extends into one end of the suck component is not higher than a bottom end of the air chamber tube, or the suck component is provided with a water storing bladder, and a port at which the extension component extends into one end of the water storing bladder is not higher than a bottom end of the air chamber tube.

In the above-mentioned technical solution of the present application, the hummingbird shooting system discloses a means for delivering, using a negative pressure siphon mode, the sugar water in the water tank from the water delivering passage into the water storing bladder of the suck component.

Further, in the hummingbird shooting system described in the present application, the body is further provided with a heating assembly for h taking the sugar water the sugar water in the water tank.

Further, in the hummingbird shooting system described in the present application, the body is further provided with a capacity monitoring assembly for monitoring the capacity of the sugar water in the water tank.

Further, in the hummingbird shooting system described in the present application, the body is further provided with a sugar quality monitoring assembly for monitoring the quality of sugar water in the water tank.

In the above-mentioned technical solution of the present application, considering that the electronic components in an equipment compartment of the body will emit heat when actually working, the water tank is probed into the equipment compartment, and the heat in the equipment compartment may be effectively delivered to the sugar water in the water tank, which may not only effectively prevent the overheat problem caused by the long-time working of a camera 1 and improve the security of the equipment, but also effectively heat the sugar water to ensure that the hummingbird may still normally takes the sugar water in cold weather. Meanwhile, the body is further provided with a heating assembly for heating the sugar water in the water tank. In addition, considering that the sugar water in the water tank may be used up, in order to remind the user to add sugar water in time, the body is provided with a capacity monitoring assembly to monitor the sugar water capacity in the water tank in real time, and when the sugar water capacity in the water tank is lower than a pre-set capacity, an alarm is given to remind the user to add sugar water to the water tank. At the same time, the body is further provided with a sugar quality monitoring assembly for monitoring the quality of the sugar water in the water tank, understanding the quality of the sugar water, and reminding the user to replace the sugar water when it deteriorates so as to ensure the health of the hummingbird. Further, in the hummingbird shooting system described in the present application, the other end of the extension component is connected to the bottom end of the body, the water delivering passage communicates with the water tank from the bottom end of the body, and the water tank supplies sugar water to the water delivering passage from the bottom end of the body;
or the other end of the extension component is connected to the middle portion of the body, the water delivering passage communicates with the water tank from the middle portion of the body, and the water tank supplies the sugar water to the water delivering passage from the middle portion of the body.

Further, in the hummingbird shooting system described in the present application, the body delivers water in the water tank to the suck component through the water delivering passage based on a communicating vessel principle, and a water level in the water tank is the same as that in the suck component;
or the suck component is provided with a water storing bladder, and the body delivers water in the water tank to the water storing bladder through the water delivering passage based on the communicating vessel principle, and the water level in the water tank is the same as that in the water storing bladder.

Further, the water tank is detachably mounted to the bottom end of the body, and the other end of the extension component is connected to the bottom end of the water tank;
or the water tank is detachably sleeved in the middle portion of the body, and the other end of the extension component is connected to a side bottom end of the water tank.

In the above-mentioned technical solution of the present application, the other end of the extension component may be controlled to be connected to the middle portion or the bottom end of the body, so that the water delivering passage communicates with the water tank from the middle portion or the bottom end of the body, so as to realize unpowered feeding of the sugar water in the water tank into the water storing bladder of the suck component based on the communicating vessel principle. The water level in the above-mentioned water tank is always the same as the water level in the water storing bladder when the communicating vessel principle is applied.

Further, in the hummingbird shooting system described in the present application, an electric water feeding mechanism is provided in the body and the electric water feeding mechanism includes a controller and a driving component, where the controller is electrically connected to the driving component, and the driving component is used for receiving a start command sent by the controller and driving the water in the water tank to be delivered to the water storing bladder via the water delivering passage.

Further, in the hummingbird shooting system described in the present application, the plurality of suck components are connected to the same extension component; a single camera is provided corresponding to one feeding assembly, or a single camera is provided corresponding to the plurality of feeding assemblies.

In the above-mentioned technical solution of the present application, in practice, the arrangement form of the above-mentioned feeding assembly may be adjusted according to specific application requirements; in some preferred cases, a single extension component may be used to connect a plurality of suck components, and at this time, the above-mentioned extension component may be simulated into a “stem”, and the above-mentioned suck components may be simulated into “flowers”, so as to simulate a landscape with a plurality of flowers growing on a single stem, thereby more perfectly simulating a real scene of stem in nature and optimizing the effect of an image of the hummingbird taken by a camera.

Further, in the hummingbird shooting system described in the present application, the camera captures an image of the hummingbird at 360 degrees in at least one dimension.

In the above-mentioned technical solution of the present application, according to actual shooting requirements, one or more cameras may be used to capture an image of the hummingbird at 360 degrees in at least one dimension so as to acquire a better image of the hummingbird, so as to facilitate a user to comprehensively observe a hummingbird's activity of taking the sugar water, and to enable the user to have an immersive experience.

In practice, when a plurality of cameras are specifically provided, the above-mentioned plurality of cameras may be specifically provided on the body and distributed around the body so as to cooperate with each other in shooting, so as to capture an image of the hummingbird at 360 degrees in at least one dimension.

The beneficial effects of the present application are as follows: the hummingbird shooting system of the present application may be effectively used for a home user or a bird research center, and may replace manual observation and shoot and record the hummingbird without interfering same, so as to facilitate the user to study the process and habits of a hummingbird in taking the sugar water. In addition, for the hummingbird shooting system designed in the present application, after an extension component is used to extend the above-mentioned suck component for the hummingbird to take the sugar water to a designated shooting position opposite to the camera, the camera may ensure that there is no artificial structure other than the feeding assembly and the hummingbird in a pre-set area for shooting, so as to perfectly simulate a real scene where the hummingbird is taking nectar in nature, so that the user may view and study the hummingbird in real time, and at the same time, obtain an image of the hummingbird which gives a very high quality and excellent approximate experience in a natural scene, which greatly facilitates the user to view and study the hummingbird.

### BRIEF DESCRIPTION OF THE DRAWINGS

FIG. 1 is a schematic structural diagram showing a hummingbird shooting system according to an embodiment of the present application.

FIG. 2 is a front structural view showing a hummingbird shooting system according to an embodiment of the present application.

FIG. 3 is an A-A sectional view showing a hummingbird shooting system as shown in FIG. 2.

FIG. 4 is an exploded structural view showing a body of a hummingbird shooting system at one view angle according to an embodiment of the present application.

FIG. 5 is an exploded structural view showing an upper cover body of a hummingbird shooting system as shown in FIG. 4 at one viewing angle.

FIG. 6 is an exploded structural view showing an upper cover body of a hummingbird shooting system as shown in FIG. 4 at another view angle.

FIG. 7 is a schematic structural diagram showing a hummingbird shooting system according to another embodiment of the present application.

FIG. 8 is an exploded structural view showing a hummingbird shooting system according to another embodiment of the present application.

FIG. 9 is a schematic structural diagram showing a hummingbird shooting system according to another embodiment of the present application, in which two ends of the extension component are connected to a water tank and an suck component, respectively.

FIG. 10 is a schematic structural diagram showing a hummingbird shooting system at a view angle according to still another embodiment of the present application.

FIG. 11 is a schematic structural diagram showing a hummingbird shooting system at another view angle according to still another embodiment of the present application.

FIG. 12 is a schematic structural diagram showing a hummingbird shooting system according to yet another embodiment of the present application.

FIG. 13 is a schematic structural diagram showing a hummingbird shooting system according to yet still another embodiment of the present application.

FIG. 14 is a cross-sectional structural view showing an suck component of a hummingbird shooting system according to an embodiment of the present application.

FIG. 15 is a schematic diagram showing a hummingbird taking sugar water from an suck component.

### DESCRIPTION OF REFERENCE NUMERALS

1. camera;
2. feeding assembly;
3. suck component; 31. suck port; 32. water storing bladder; 33. flower simulating component; 34. duckbill valve;
4. extension component; 41. water delivering passage;
5. body; 51. lower housing; 52. upper cover body; 521. outer cover body; 522. inner cover body; 53. water tank; 54. air chamber tube; 55. internal venting port; 56. external venting port; 57. sealing gasket; 58. recessed portion; 59. communication hole; 510. annular protrusion;
6. hook;
7. mounting frame.

### DETAILED DESCRIPTION OF THE EMBODIMENTS

In order to explain the technical contents, the objects, and the effects of the present application in detail, the embodiments will be described below referring to the accompanying drawings.

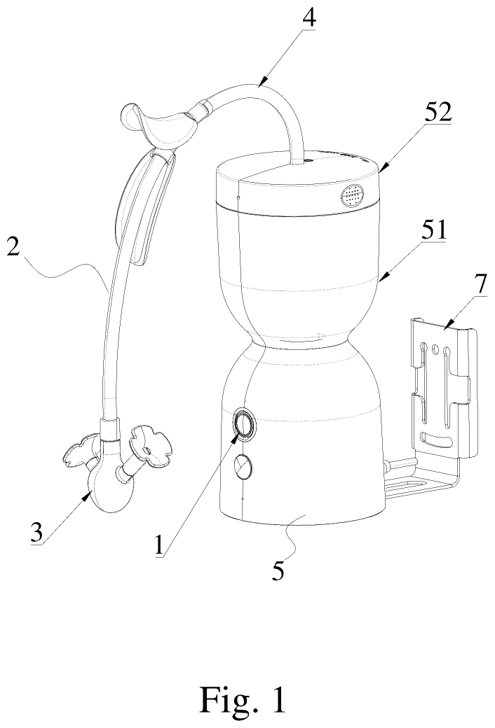

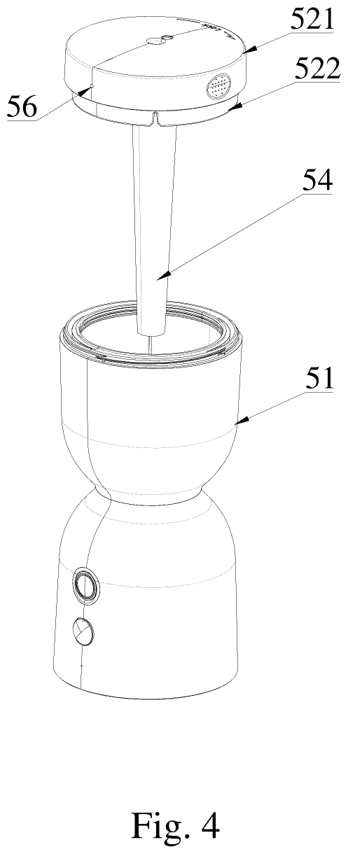

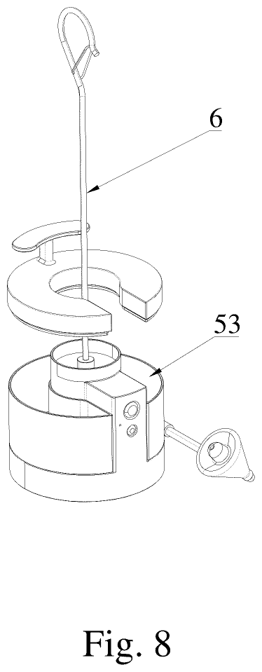

Referring to FIGS. 1-15, in order to facilitate a user to view and study hummingbirds, the present application designs a new hummingbird shooting system including: a feeding assembly 2 and a camera 1, where the feeding assembly 2 specifically includes: an suck component 3 and an extension component 4, the suck component 3 being used for suck of a hummingbird, the extension component 4 being connected to the suck component 3, and the extension component 4 being used for extending the suck component 3 to a designated shooting position opposite to the camera 1 for the camera 1 to capture an image of the hummingbird in a pre-set area according to shooting requirements when the hummingbird is taking sugar water; where the image of the hummingbird includes: at least one of the hummingbird, the suck component, and the extension component. The above-mentioned suck component 3 is used for suck of the hummingbird, and the extension component 4 is controlled to be connected to the suck component 3, and the suck component 3 is extended to a designated shooting position opposite to the camera 1 by means of the support and position adjustment of the above-mentioned extension component 4, thereby allowing the camera 1 to capture images of the hummingbird in a pre-set area according to shooting requirements when the hummingbird is taking sugar water.

At least one group or multiple groups of the feeding assemblies 2 and the cameras 1 may be provided, and the number is not limited. At least one group or multiple groups of the suck components 3 and the extension components 4 in the feeding assembly 2 may also be provided; one or more suck components 3 may be connected to one extension component 4; one camera 1 may shoot one or more suck components 3, and may also shoot one or more extension components 4, which may be specifically set according to the shooting requirements.

It may be seen therefrom that in the present application, for the problem that it is difficult to observe a hummingbird artificially in the prior art, sugar water may be placed in the suck component 3 of the hummingbird shooting system to induce the hummingbird to take the sugar water so as to allow the hummingbird to approach the suck component 3, and at this time, the above-mentioned hummingbird and the process in which the hummingbird takes the sugar water may be shot by the camera 1; because the user does not need to observe the hummingbird at the near point, it may effectively eliminate the hummingbird's vigilance and provide great convenience for the user to view and study the hummingbird in nature.

It should be noted that in the present application, the image of the hummingbird captured by the above-mentioned camera 1 when the hummingbird takes the sugar water may specifically include: at least one of a hummingbird, the suck component 3, and the extension component 4. Based on this arrangement, it may be ensured that there is no structure other than the feeding assembly 2 and the hummingbird in the captured image of the hummingbird, thereby perfectly simulating a real scene where the hummingbird sucks nectar in nature and obtaining a more beautiful image of the hummingbird.

Accordingly, when the hummingbird shooting system is actually applied, a user may rationally control the pre-set area range shot by the above-mentioned camera 1 so as to ensure the content contained in the output image of the hummingbird according to his own requirements; for example, when a close-up view of the hummingbird taking the sugar water is required, the image of the hummingbird in the pre-set area captured by the above-mentioned camera 1 may be controlled to include the hummingbird instead of the suck component 3 and the extension component 4 in the feeding assembly 2, so as to maximally simulate a real scene of the hummingbird taking nectar in nature.

It is obvious that as shown in FIG. 1, in some other embodiments, in order to improve the aesthetics of the image of the hummingbird, so that a user may obtain a more aesthetic image when observing the image of the hummingbird, in practice, the appearance of the above-mentioned suck component 3 and the extension component 4 may be adaptively adjusted, so that the suck component 3 and the extension component 4 have a simulated shape so as to be more in line with the form of plants in nature. Alternatively, the suck component 3 has a shape of a simulated flower, the extension component 4 has a shape of simulated stem of the flower, and simulated leaves may be further provided on the extension component 4.

At this time, when shooting a hummingbird taking the sugar water, a user may preferably control that the image of the hummingbird shot by the camera 1 further includes at least part of the suck component 3 besides the hummingbird. For example, an image of the hummingbird further includes an at least partially simulated flower shape besides the hummingbird.

Or the image of the hummingbird includes the hummingbird, at least part of the suck component 3 and at least part of the extension component 4 together, so as to conform more to the natural scene. For example, the image of the hummingbird includes an at least partially simulated flower shape and at least a simulated stem shape besides the hummingbird.

Accordingly, referring to FIGS. 1, 14 and 15, in the hummingbird shooting system in the present application, the suck component 3 in the feeding assembly 2 is a rather important component, and it has been found that the suck component 3 commonly used in the prior art is generally relatively simple and does not have much consideration in the use of materials, which generally has the following problems:
(1) The sugar water in the suck component 3 easily deteriorates and its sealing property is poor, and ants and bees' fighting for the sugar water would easily contaminate the sugar water and adversely affect the shooting action of the camera;
(2) The material of the suck port 31 of the suck component 3 is relatively rigid, has poor simulation, and is liable to cause injury to the hummingbird.

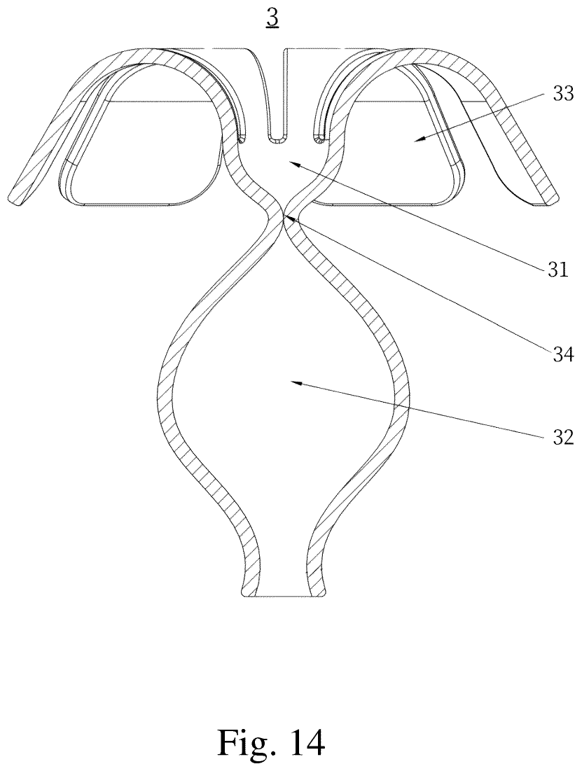

To this end, as shown in FIG. 14, in the present application, a structurally optimized design is made for the suck component 3 of the feeding assembly 2, where the suck component 3 may be specifically provided with a water storing bladder 32 and at least one suck port 31, and the above-mentioned suck port 31 may communicate with the water storing bladder 32, so that the beak of a hummingbird passes through the suck port 31 and extends into the water storing bladder 32 to suck the sugar water.

In practice, the above-mentioned water storing bladder 32 may store water independently or may be connected to an external water tank 53, and the water tank supplies the sugar water 53, which does not affect the image capturing of a process in which the hummingbird takes the sugar water.

It should be noted that, in consideration that the leakproofness of an suck port 31 of an suck component 3 is poor, and it is easy to cause deterioration of sugar and water and cause the ants and bees to fight for the sugar water; as shown in FIG. 14, in the present application, in practice, a duckbill valve 34 may also be provided at the above-mentioned suck port 31, where the duckbill valve 34 is tightly closed in a conventional state and may be easily extended through and opened by the beak of the hummingbird, so as to prevent ants and bees as well as prevent deterioration of the sugar water and provide the sugar water for the hummingbird.

It is obvious that in order to obtain a better implementation effect, the above-mentioned duckbill valve 34 and the suck port 31 may both be specifically prepared from a flexible material, so as to avoid the hummingbird being injured when it is taking the sugar water due to excessive rigidity of the material.

In addition, as shown in FIG. 1, in some embodiments, after selecting a flexible material, the suck port 31 may not be provided with a duckbill valve, which may specifically limit the diameter of the suck port 31, i.e., the suck port 31 is provided with an suck slit of a pre-set size, which may also prevent the ants and bees while not affecting the beak of the hummingbird extending into the water storing bladder 32.

In addition, as shown in FIGS. 1 and 14, in order to improve the simulation of the suck component 3 and better simulate a scene where the hummingbird is taking the sugar water in nature to attract the hummingbird, in the present application, a flower simulating component 33 is further provided on the suck component 3, so that the flower simulating component 33 may be used to attract suck of the hummingbird, and the aesthetic effect of the image of the hummingbird captured by the camera 1 may be improved, and the real scene of simulating the hummingbird taking the nectar in nature may be restored to the maximum extent.

In practice, as shown in FIG. 14, the above-mentioned flower simulating component 33 may be connected to an edge of the suck port 31 of the above-mentioned suck component 3 so as to achieve an effect of simulating attraction of hummingbirds; in order to facilitate preparation, the above-mentioned flower simulating component 33 may be an integral extension of the above-mentioned suck port 31, so as to make the integrity stronger; it is obvious that the above-mentioned flower simulating component 33 may also be detachably connected to an edge of the suck port 31 of the above-mentioned suck component 3 in consideration of the damage and aging problems that may exist in the natural environment, thereby facilitating the user to detach and replace a new flower simulating component 33.

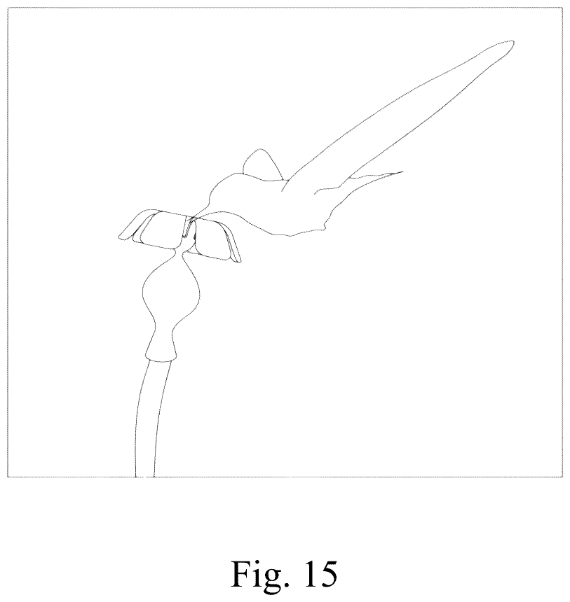

In summary, in the hummingbird shooting system described in the present application, the suck component 3 with an optimized design may effectively seal the sugar water in the water storing bladder 32 by providing a duckbill valve 34 or an suck slit, preventing the sugar water from deteriorating, and preventing ants, bees, etc. from entering; at the same time, the flower simulating component 33 is optimized and the appropriate materials are selected to ensure that the hummingbird may normally suck the sugar water, and the beak of the hummingbird will be injured due to strong rigidity; at this time, with the camera 1, a shooting record of the hummingbird taking the sugar water may be realized, effectively simulating a scene where the hummingbird is taking the nectar, as shown in FIG. 15.

Further, it should be pointed out that the above-mentioned suck component 3 is mounted in particular via an extension component 4, and the mounting position of the extension component 4 of the hummingbird shooting system may be various, which may be adjusted according to the specific application environment, and the extension component 3 may be used to adjust the relative position of the above-mentioned suck component 3 and the camera 1.

In practice, the above-mentioned extension component 4 may have one end connected to the suck component 3 and has the other end connected to the ground or another mounting position so as to support the suck component 3; for example, in some embodiments, the other end of the extension component 4 may be connected to a tree, a wall, or a peg, and the user may adjust the form and position of the extension component 4 and the suck component 3 as desired.

Accordingly, as shown in FIGS. 1 to 13, in order to improve the reliability, integration and convenience of the hummingbird shooting system in practice, and facilitate the mounting of various components of the hummingbird shooting system, the hummingbird shooting system may be further provided with a body 5 having an unlimited appearance, and the body may be used to connect the extension component 4 so that the mounting position of the extension component 4 is more secure and reliable, thereby effectively reducing the possible adverse interference of the outdoor environment to the extension component 4 and the suck component 3 of the feeding assembly 2.

In practice, in the embodiments of FIGS. 1-13, the camera 1 described above may also be provided in particular on the body 5. One or more cameras 1 may be provided at the top end, the bottom end or the periphery of the body 5 according to a shooting angle and shooting requirements. The suck component 3 is extended from the body 5 to the outside of the body 5 and a designated shooting position opposite to the camera 1 through the support extension of the extension component 4; when a hummingbird is taking the sugar water, the camera 1 captures an image of the hummingbird in a pre-set area according to shooting requirements, so that the body 5 will not be shot; and by the integration of the body 5, the relative positions of the camera 1 and the feeding assembly 2 may be stably set, and the user may complete the mounting only by mounting the body 5, and the redundant components will not be shot; it is obvious that in some embodiments it is also possible to use a split-type design, i.e., the camera 1 is not provided on the body 5, but is provided around the body 5 and shoots the suck component 3 connected to one end of the extension component 4 connected to the body 5 and does not shoot the body 5.

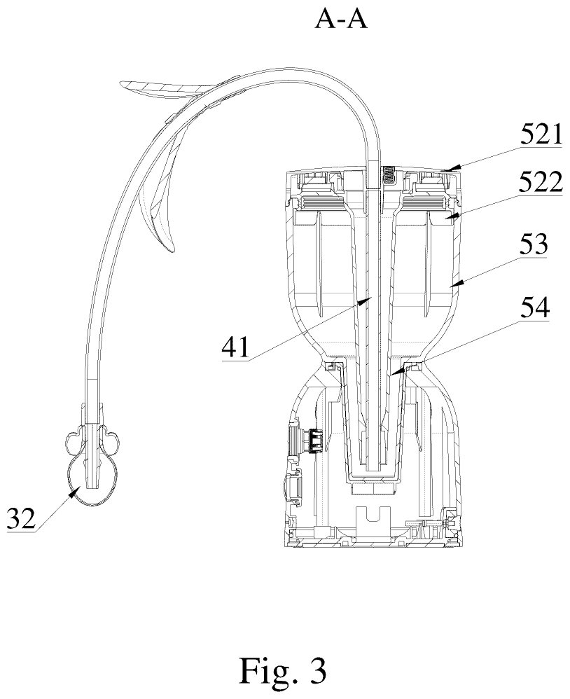

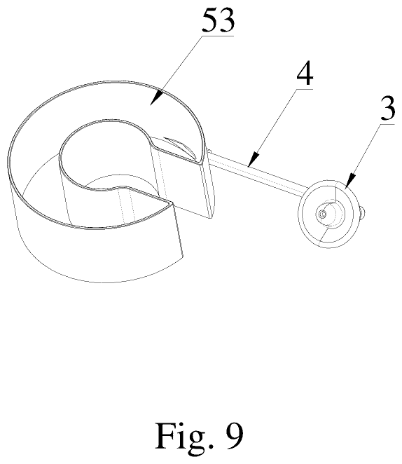

Based on the above-mentioned contents, in consideration of an outdoor environment, a user may need to be able to supplement the sugar water once at a long time interval; therefore, in practice, it is also possible to provide a water tank 53 holding the sugar water on the body 5, as shown in FIG. 9, and provide the above-mentioned extension component 4 to be provided with a water delivering passage 41 (see FIG. 3) so as to communicate the water tank 53 and the suck component 3 with the water delivering passage 41, thereby facilitating the delivery of the sugar water stored in the water tank 53 from the water delivering passage 41 to the suck component 3, and ensuring timely supplement when there is shortage of the sugar water in the suck component 3. Considering that the sugar water in the water tank 53 may also be used up, in order to remind the user to add the sugar water in time, the body 5 may also be provided with a capacity monitoring assembly to monitor the sugar water capacity in the water tank 53 in real time, and when the sugar water capacity in the water tank 53 is lower than a pre-set capacity, an alarm is given to remind the user to add the sugar water to the water tank 53. The capacity monitoring assembly may be used as an electrode sensor, a capacitance sensor, an ultrasonic sensor, an infrared sensor, a gravity sensor, etc. to monitor the liquid level or weight.

It is obvious that in practice, the suck component 3 may also be provided with a certain independent water storing capability, i.e., the suck component 3 may be provided with an independent water storing bladder 32, so that the above-mentioned water delivering passage 41 may communicate the water tank 53 and the water storing bladder 32, and may deliver the sugar water in the water tank 53 to the water storing bladder 32 for storage, so as to facilitate a hummingbird to extend its beak into the water storing bladder 32 to suck the sugar water, so as to facilitate shooting a process in which the hummingbird takes the sugar water.

It is important to note that in the present application, when the other end of the extension component 4 is connected to the body 5, depending on the different positions of the other end of the extension component 4 connected to the body 5, a variety of sugar water drive forms may be used to deliver the sugar water in the water tank 53 to the water delivering passage 41 for delivery to the suck component 3.

In practice, the other end of the above-mentioned extension component 4 may be connected to at least one of the top end, the bottom end and the middle portion of the above-mentioned body 5:
Method one: when the other end of the extension component 4 is connected to the top end of the body 5, the water delivering passage 41 in the extension component 4 communicates with the water tank 53 from the top end of the body 5, and the above-mentioned water tank 53 supplies sugar water to the water delivering passage 41 from the top end of the body 5;
Method two: when the other end of the extension component 4 is connected to the bottom end of the body 5, the water delivering passage 41 in the extension component 4 communicates with the water tank 53 from the bottom end of the body 5, and the above-mentioned water tank 53 supplies sugar water to the water delivering passage 41 from the bottom end of the body 5;
Method three: when the other end of the extension component 4 is connected to the middle portion of the body 5, the water delivering passage 41 in the extension component 4 communicates with the water tank 53 from the middle portion of the body 5, and the water tank 53 supplies sugar water to the water delivering passage 41 from the middle portion of the body 5.

It should be noted that when the connection mode of the above-mentioned method one is used, since the water delivering passage 41 communicates with the water tank 53 from the top end of the body 5, and the maximum height of the sugar water level in the water tank 53 is lower than the maximum height of the above-mentioned water delivering passage 41, the communicating vessel principle cannot be used for unpowered feeding of the sugar water in the water tank 53 into the water storing bladder 32 of the suck component 3.

For this reason, under this connection condition, the user may send the sugar water in the water tank 53 from the water delivering passage 41 into the water storing bladder 32 of the suck component 3 in an electric drive mode (electric drive) or a negative pressure siphon mode (atmospheric pressure power); in practice, a suitable driving form may be selected according to specific application requirements.

When using the above-mentioned method and considering using a negative pressure siphon method (atmospheric pressure power) to send the sugar water in the water tank 53 from the water delivering passage 41 into the water storing bladder 32 of the suck component 3, the body 5 of the hummingbird shooting system may be specifically provided to include a lower housing 51 and an upper cover body 52, and the upper cover body 52 and the lower housing 51 together form a water storing chamber of the water tank 53. The upper cover body 52 may be mounted to the lower housing 51 in a covering manner and, when a downward pressure is applied, may be pressed and sealedly cooperated with the lower housing 51 and compress the water storing chamber space to achieve siphoning.

At this time, the upper cover body 52 may specifically include an outer cover body 521 capable of being rotatably covered on the top end of the inner cover body 522, an inner cover body 522, and an air chamber tube 54. The top end of the air chamber tube 54 is connected to the inner cover body 522, and the bottom end may be placed inside the water storing chamber. In the upper cover body 52, a venting passage is provided between the outer cover body 521 and the inner cover body 522 for communicating the top end of the air chamber tube 54 with the external atmosphere. When the outer cover body 521 is in the first position, the above-mentioned venting passage is closed, and the outer cover body 521, the inner cover body 522 and the air chamber tube 54 are non-conductive; when the outer cover body 521 rotates with respect to the inner cover body 522 and rotates to the second position, the above-mentioned venting passage is opened, and the outer cover body 521, the inner cover body 522 and the air chamber tube 54 are conductive.

In practice, the other end of the extension component 4 passes through the upper cover body 52 from the top end of the body 5, extends into the air chamber tube 54 and extends out of the bottom end of the air chamber tube 54 so as to extend into the interior of the water storing chamber, so that the water delivering passage 41 may communicate with the water storing chamber. The outer cover body 521 is rotatably and sealedly covered on the top end of the inner cover body 522 and detachably assembled with the lower housing 51, and the outer periphery of the top end of the inner cover body 522 is sealedly assembled with the lower housing 51 in a matching manner.

When the upper cover body 52 is initially placed on the lower housing 51, the outer cover body 521 is located at the first position, the venting passage provided in the upper cover body 52 is in a closed state, i.e., the air chamber tube 54 is non-conductive to the outside, at this time, the air pressure in the air chamber tube 54 is in a sealed atmospheric pressure state, and there is air in the air chamber tube 54, so that when the air chamber tube 54 extends into the sugar water in the water storing chamber, the sugar water in the water storing chamber does not enter the air chamber tube 54.

When a user applies downward pressure to the upper cover body 52, the upper cover body 52 presses down and sealedly cooperates a lower housing 51, which compresses the water storing chamber space and allows the atmospheric pressure within the water storing chamber to be greater than the normal atmospheric pressure outside. At this time, the inner cover body 522 may match and seal with the lower housing 51, and the outer cover body 521 may rotate and move downwards compared with the inner cover body 522, driving the inner cover body 522 to move downwards to compress the air in the water storing chamber space, resulting in a pressure difference between the inside and outside of the air chamber tube 54 provided in the sugar water, and since the other end of the extension component 4 extends out of the bottom end of the air chamber tube 54, the pressure difference will send the sugar water into the water delivering passage 41 in the extension component 4, and flow from the water delivering passage 41 to the water storing bladder 32 of the suck component 3, and then evacuate the gas in the water delivering passage 41. As the sugar water continuously flows from the water delivering passage 41 into the water storing bladder 32 of the suck component 3, the sugar water in the water storing chamber gradually becomes less, the space in the water storing chamber decreases, returns to the external normal atmospheric pressure and continuously becomes a negative pressure. When the outer cover body 521 moves to a second position, the upper cover body 52 is assembled with the lower housing 51. At this time, the venting passage provided in the upper cover body 52 is conductive, and the atmospheric pressure in the above-mentioned air chamber tube 54 is leveled with the external conventional atmospheric pressure. At this time, the atmospheric pressure in the water storing chamber, the water pressure of the sugar water in the water tank 53 and the atmospheric pressure in the air chamber tube 54, and the atmospheric pressure in the water storing bladder 32 work together to form a balance, and a gas-liquid balance level is formed at the end surface of the bottom end of the air chamber tube 54. Both the sugar water in the water delivering passage 41 is free of air, and the suck component 3 is also at normal atmospheric pressure, thereby achieving siphon delivery and liquid level balance with the suck component 3. In order to maintain the liquid level balance, increase the liquid level stability of the sugar water in the water storing bladder 32, eliminate the shaking of the sugar water, etc., the extension component 4 extends into the suck component 3 or one port of the water storing bladder 32 is not higher than the bottom end height of the air chamber tube 54, and may be close to the bladder bottom of the water storing bladder 32. In this way, when the sugar water is contained in the water storing bladder 32 and the sugar water immerses the port at one end of the extension component 4, the liquid level in the sugar water bladder 32 and the bottom end of the air chamber tube 54 may form a liquid level consistency, and the port at one end of the extension component 4 is immersed in the sugar water and does not drip due to shaking, so that the stability of the sugar water bladder 32 may be better maintained.

In addition, in order to enable the sugar water in the water storing chamber to be almost completely delivered to the water storing bladder 32 of the suck component 3 and prevent the sugar water from overflowing, when the upper cover body 52 or the outer cover body 521 is in the second position, the bottom end of the air chamber tube 54 is provided, and the other end of the extension component 4 is close to the lowest position of the water tank 53. The bottom of the water storing bladder 32 is not higher than the bottom end of the air chamber tube 54. The suck port 31 of the suck component 3 is not lower than the bottom end of the air chamber tube 54. Considering that the suck depth of the hummingbird is generally about 4 cm, the height of the bottom of the suck port 31 and the water storing bladder 32 may not exceed 4 cm, so that the hummingbird may suck the sugar water in the water storing bladder 32 completely.

When the water level in the suck component 3 or the water storing bladder 32 is lower than the bottom end of the air chamber tube 54 placed inside the water storing chamber, under the action of negative pressure siphon, the sugar water in the water storing chamber is continuously siphoned into the water storing bladder 32 of the suck component 3 via a water delivering passage 41, thereby continuously supplementing water.

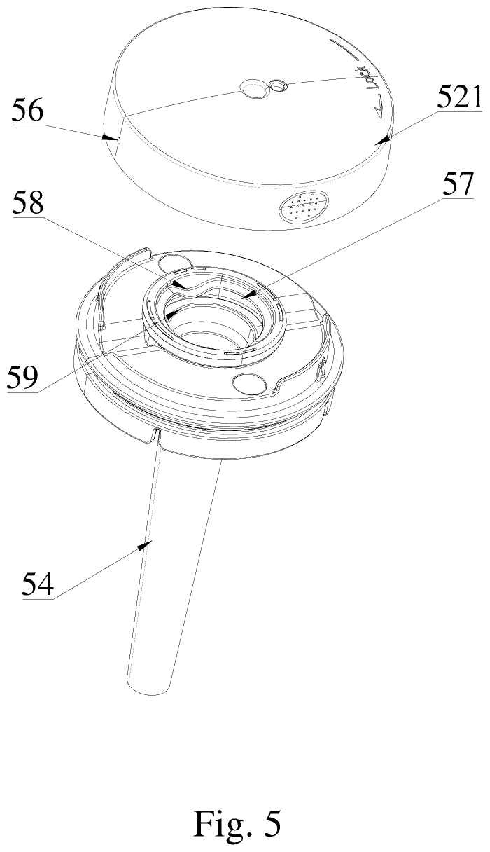

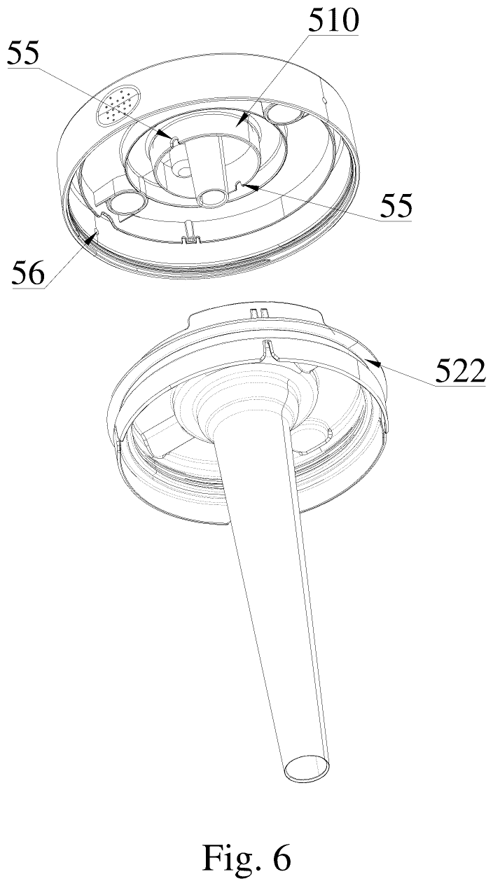

It should be noted that in the upper cover body 52, the design of the above-mentioned venting passage is a core design, and in order to facilitate understanding the process of opening and closing the venting passage, as shown in FIGS. 5 and 6, in practice, a communication hole 59 is provided at the top of the inner cover body 522 of the upper cover body 52, the communication hole 59 correspondingly communicates with the air chamber tube 54, and a sealing gasket 57 is provided on a peripheral wall of the communication hole 59, the sealing gasket 57 has a certain thickness of a gasket in the vertical height direction, and a recessed portion 58 is provided thereon, the thickness of the gasket of the recessed portion 58 is less than that of other parts. When the outer cover body 521 and the inner cover body 522 of the upper cover body 52 are mounted, both the outer cover body 521 and the inner cover body 522 are correspondingly provided with magnetic components, so that the two are magnetically attracted and the outer cover body 521 is simply and directly positioned at the first position.

An annular protrusion is provided at one end of the outer cover body 521 corresponding to the inner cover body 522, and when the outer cover body 521 and the inner cover body 522 are correspondingly mounted in a matching manner, the annular protrusion 510 may be provided corresponding to the above-mentioned communication hole 59, and the communication hole 59 and the annular protrusion 510 is sealable by the sealing gasket 57 when the outer cover body 521 is in the first position. The annular protrusion 510 is provided with an internal venting port 55, and when the outer cover body 521 is positioned at the first position, the above-mentioned internal venting port 55 is provided at a thicker part of the sealing gasket 57, and at this time, the internal venting port 55 and the communication hole 59 cannot achieve conduction.

Accordingly, an external venting port 56 is further provided on an outer wall of the outer cover body 521, and after the outer cover body 521 and the inner cover body 522 are mounted in a matching manner, the conduction passage between the external venting port 56 and the internal venting port 55 is the venting passage. At this time, when the outer cover body 521 is in the above-mentioned first position, the internal venting port 55 is blocked, the external venting port 56, the internal venting port 55 and the communication hole 59 are non-conductive, and the venting passage is closed.

In practice, when the outer cover body 521 rotates compared with the inner cover body 522, the annular protrusion 510 on the outer cover body 521 rotates together; when the outer cover body 521 rotates to the second position, the internal venting port 55 of the annular protrusion 510 correspondingly rotates to the recessed portion 58 of the sealing gasket 57, the thickness of a gasket of the recessed portion 58 is small, and the internal venting port 55 cannot be blocked; and the sealing gasket 57 does not seal the internal venting port 55, the internal venting port 55 is conductive to the communication hole 59, and the communication hole 59 is further conductive to the external venting port 56, and the venting passage is conductive.

When the method two or method three is adopted for connection, that is, the other end of the extension component 4 is provided to be connected to the middle portion or bottom end of the body 5 so that the water delivering passage 41 communicates with the water tank 53 from the middle or bottom end of the body 5. At this time, unpowered feeding of the sugar water in the water tank 53 into the suck component 3 or the water storing bladder 32 may be realized based on the communicating vessel principle. It is obvious that it is also possible to supply the sugar water in the water tank 53 to the water delivering passage 41 in the form of an electric drive. The water level in the above-mentioned water tank 53 is always the same as the water level in the suck component 3 or the water storing bladder 32 when the communicating vessel principle is applied. In order to prevent the sugar water from overflowing, the maximum level of the water tank 53 is not higher than the maximum level in the suck component 3.

The body 5 may be provided with a water outlet control assembly which drives the water in the water tank 53 to be delivered to the water storing bladder 32 through the water delivering passage 41 on the basis of the communicating vessel principle, and the water level in the water tank 53 is the same as that in the water storing bladder 32. In order to prevent the sugar water from overflowing, the maximum level of the water tank 53 is not higher than the maximum level in the suck component 3.

Whatever the above-mentioned method is selected for connection, in practice, when the sugar water is sent to the water delivering passage 41 in an electrically driven manner, an electric water feeding mechanism may be specifically provided in the body 5 of the hummingbird shooting system, and the electric water feeding mechanism may include: a controller and a driving component, where the driving component may be specifically selected as a water pump or a gas pump, and the controller is electrically connected to the driving component, and the driving component is used for receiving a start command sent by the controller and driving the sugar water in the water tank 53 to be delivered to the water storing bladder 32 of the suck component 3 via the water delivering passage 41 in the extension component 4.

Accordingly, in the hummingbird shooting system designed in the present application, the arrangement form of the above-mentioned feeding assembly 2 may be adjusted according to specific application requirements; in some preferred cases, a single extension component 4 may be used to connect a plurality of suck components 3, and at this time, the above-mentioned extension component 4 may be simulated into a “stem”, and the above-mentioned suck components 3 may be simulated into “flowers”, so as to simulate a landscape with a plurality of flowers growing on a single stem, thereby more perfectly simulating a real scene of stem in nature and optimizing the effect of an image of the hummingbird taken by a camera 1.

Accordingly, in other preferred cases, simulated leaves may also be provided on the above-mentioned extension component 4, and the simulated leaves may contain chemical materials for driving ants, or the whole extension component 4, the flower simulating component 33 and the suck component 3 contain chemical materials for driving ants; and the chemical materials for repelling ants may be specifically capsaicin, aromatic hydrocarbons, etc. selected for use.

In addition, according to actual shooting requirements, a single camera 1 is provided corresponding to one feeding assembly 2, or a single camera 1 is provided corresponding to a plurality of feeding assemblies 2; in addition, one or more cameras may be used to capture an image of the hummingbird at 360 degrees in at least one dimension so as to acquire a better image of the hummingbird, so as to facilitate a user to comprehensively observe a hummingbird's activity of taking the sugar water, and to enable the user to have an immersive experience.

In practice, when a plurality of cameras are specifically provided, the above-mentioned plurality of cameras may be specifically provided on the body and distributed around the body 5. Further, a plurality of cameras 1 may be used in cooperation with each other for shooting and capturing images of hummingbirds at 360 degrees in at least one dimension.

In order to facilitate understanding, referring to FIGS. 1-13, the applicant specifically explains the hummingbird shooting system of the present application through the following specific embodiments:

### Embodiment 1

As shown in FIGS. 1 to 6, in the first embodiment, the hummingbird shooting system of the present application specifically includes a body 5, a single camera 1, and a single feeding assembly 2 including an suck component 3 and an extension component 4 having one end connected to the suck component 3 and the other end connected to the top end of the body 5.

In the present embodiment, the above-mentioned camera 1 is provided on the body 5, and the camera 1 is provided corresponding to the suck component 3 of the above-mentioned feeding assembly 2, so as to capture an image of the hummingbird in a pre-set area according to shooting requirements when the hummingbird is taking sugar water; and the image of the hummingbird includes at least one of a hummingbird, the suck component 3 corresponding to the feeding assembly 2, and the extension component 4.

It should be noted that in the present embodiment, the body 5 is provided with a water tank 53 and the extension component 4 is provided with a water delivering passage 41 for communicating the water tank 53 and the suck component 3 via the water delivering passage 41. The suck component 3 is provided with a water storing bladder 32, and the above-mentioned water delivering passage 41 communicates with a water tank 53 and a water storing bladder 32 of the suck component 3.

In the present embodiment, in this connection, the sugar water in the water tank 53 is delivered from the water delivering passage 41 to the water storing bladder 32 of the suck component 3 by means of negative pressure siphon. It is specifically provided that the body 5 includes a lower housing 51 and an upper cover body 52, and the upper cover body 52 and the lower housing 51 together form a water storing chamber of the above-mentioned water tank 53.

At this time, the upper cover body 52 may specifically include an outer cover body 521 capable of being rotatably covered on the top end of the inner cover body 522, an inner cover body 522, and an air chamber tube 54. The top end of the air chamber tube 54 is connected to the inner cover body 522, and the bottom end may be placed inside the water storing chamber. In the upper cover body 52, a venting passage is provided between the outer cover body 521 and the inner cover body 522 for communicating the top end of the air chamber tube 54 with the external atmosphere. When the outer cover body 521 is in the first position, the above-mentioned venting passage is closed, and the outer cover body 521, the inner cover body 522 and the air chamber tube 54 are non-conductive; when the outer cover body 521 rotates with respect to the inner cover body 522 and rotates to the second position, the above-mentioned venting passage is opened, and the outer cover body 521, the inner cover body 522 and the air chamber tube 54 are conductive.

In practice, the other end of the extension component 4 passes through the upper cover body 52 from the top end of the body 5, extends into the air chamber tube 54 and extends out of the bottom end of the air chamber tube 54 so as to extend into the interior of the water storing chamber, so that the water delivering passage 41 may communicate with the water storing chamber. The outer cover body 521 is rotatably and sealedly covered on the top end of the inner cover body 522 and detachably assembled with the lower housing 51, and the outer periphery of the top end of the inner cover body 522 is sealedly assembled with the lower housing 51 in a matching manner. Thus, when the outer cover body 521 is sealedly covered on the top end of the inner cover body 522, and the top end of the inner cover body 522 is sealedly assembled with the lower housing 51, the upper cover body 52 is sealedly assembled with the lower housing 51.

When the upper cover body 52 is initially placed on the lower housing 51, the outer cover body 521 is located at the first position, the venting passage provided in the upper cover body 52 is in a closed state, i.e., the air chamber tube 54 is non-conductive to the outside, at this time, the air pressure in the air chamber tube 54 is in a sealed atmospheric pressure state, and there is air in the air chamber tube 54, so that when the air chamber tube 54 extends into the sugar water in the water storing chamber, the sugar water in the water storing chamber does not enter the air chamber tube 54.

When a user applies downward pressure to the upper cover body 52, the upper cover body 52 presses down and sealedly cooperates a lower housing 51, which compresses the water storing chamber space and allows the atmospheric pressure within the water storing chamber to be greater than the normal atmospheric pressure outside. At this time, the inner cover body 522 may match and seal with the lower housing 51, and the outer cover body 521 may rotate and move downwards compared with the inner cover body 522, driving the inner cover body 522 to move downwards to compress the air in the water storing chamber space, resulting in a pressure difference between the inside and outside of the air chamber tube 54 provided in the sugar water, and since the other end of the extension component 4 extends out of the bottom end of the air chamber tube 54, the pressure difference will send the sugar water into the water delivering passage 41 in the extension component 4, and flow from the water delivering passage 41 to the water storing bladder 32 of the suck component 3, and then evacuate the gas in the water delivering passage 41. As the sugar water continuously flows from the water delivering passage 41 into the water storing bladder 32 of the suck component 3, the sugar water in the water storing chamber gradually becomes less, the space in the water storing chamber decreases, returns to the external normal atmospheric pressure and continuously becomes a negative pressure. When the outer cover body 521 moves to a second position, the upper cover body 52 is assembled with the lower housing 51. At this time, the venting passage provided in the upper cover body 52 is conductive, and the atmospheric pressure in the above-mentioned air chamber tube 54 is leveled with the external conventional atmospheric pressure. At this time, the atmospheric pressure in the water storing chamber, the water pressure of the sugar water in the water tank 53 and the atmospheric pressure in the air chamber tube 54, and the atmospheric pressure in the water storing bladder 32 work together to form a balance, and a gas-liquid balance level is formed at the end surface of the bottom end of the air chamber tube 54. Both the sugar water in the water delivering passage 41 is free of air, and the suck component 3 is also at normal atmospheric pressure, thereby achieving siphon delivery and liquid level balance with the suck component 3. In order to maintain the liquid level balance, increase the liquid level stability of the sugar water in the water storing bladder 32, eliminate the shaking of the sugar water, etc., the extension component 4 extends into one port of the water storing bladder 32 is not higher than the bottom end height of the air chamber tube 54, and may be close to the bladder bottom of the water storing bladder 32. In this way, when the sugar water is contained in the water storing bladder 32 and the sugar water immerses the port at one end of the extension component 4, the liquid level in the sugar water bladder 32 and the bottom end of the air chamber tube 54 may form a liquid level consistency, and the port at one end of the extension component 4 is immersed in the sugar water and does not drip due to shaking, so that the stability of the sugar water bladder 32 may be better maintained.

In addition, in order to enable the sugar water in the water storing chamber to be almost completely delivered to the water storing bladder 32 of the suck component 3 and prevent the sugar water from overflowing, when the upper cover body 52 or the outer cover body 521 is in the second position, the bottom end of the air chamber tube 54 is provided, and the other end of the extension component 4 is close to the lowest position of the water tank 53. The bottom of the water storing bladder 32 is not higher than the bottom end of the air chamber tube 54. The suck port 31 of the suck component 3 is not lower than the bottom end of the air chamber tube 54. Considering that the suck depth of the hummingbird is generally about 4 cm, the height of the bottom of the suck port 31 and the water storing bladder 32 may not exceed 4 cm, so that the hummingbird may suck the sugar water in the water storing bladder 32 completely.

When the water level in the suck component 3 or the water storing bladder 32 is lower than the bottom end of the air chamber tube 54 placed inside the water storing chamber, under the action of negative pressure siphon, the sugar water in the water storing chamber is continuously siphoned into the water storing bladder 32 of the suck component 3 via a water delivering passage 41, thereby continuously supplementing water.

It should be noted that in the upper cover body 52, the design of the above-mentioned venting passage is a core design, and in order to facilitate understanding the process of opening and closing the venting passage, as shown in FIGS. 5 and 6, in practice, a communication hole 59 is provided at the top of the inner cover body 522 of the upper cover body 52, the communication hole 59 correspondingly communicates with the air chamber tube 54, and a sealing gasket 57 is provided on a peripheral wall of the communication hole 59, the sealing gasket 57 has a certain thickness of a gasket in the vertical height direction, and a recessed portion 58 is provided thereon, the thickness of the gasket of the recessed portion 58 is less than that of other parts; when the outer cover body 521 and the inner cover body 522 of the upper cover body 52 are mounted, both the outer cover body 521 and the inner cover body 522 are correspondingly provided with magnetic components, so that the two are magnetically attracted and the outer cover body 521 is simply and directly positioned at the first position.

An annular protrusion is provided at one end of the outer cover body 521 corresponding to the inner cover body 522, and when the outer cover body 521 and the inner cover body 522 are correspondingly mounted in a matching manner, the annular protrusion 510 may be provided corresponding to the above-mentioned communication hole 59, and the communication hole 59 and the annular protrusion 510 are sealed using the above-mentioned sealing gasket 57; the annular protrusion 510 is provided with an internal venting port 55, and when the outer cover body 521 is positioned at the first position, the above-mentioned internal venting port 55 is provided at a thicker part of the sealing gasket 57, and at this time, the internal venting port 55 and the communication hole 59 cannot achieve conduction.

Accordingly, an external venting port 56 is further provided on an outer wall of the outer cover body 521, and after the outer cover body 521 and the inner cover body 522 are mounted in a matching manner, the conduction passage between the external venting port 56 and the internal venting port 55 is the venting passage. At this time, when the outer cover body 521 is in the above-mentioned first position, the internal venting port 55 is blocked, and the venting passage is closed.

In practice, when the outer cover body 521 rotates compared with the inner cover body 522, the annular protrusion 510 on the outer cover body 521 rotates together; when the outer cover body 521 rotates to the second position, the internal venting port 55 of the annular protrusion 510 correspondingly rotates to the recessed portion 58 of the sealing gasket 57, the thickness of a gasket of the recessed portion 58 is small; the internal venting port 55 is conductive to the communication hole 59, and the communication hole 59 is further conductive to the external venting port 56, and the venting passage is opened.

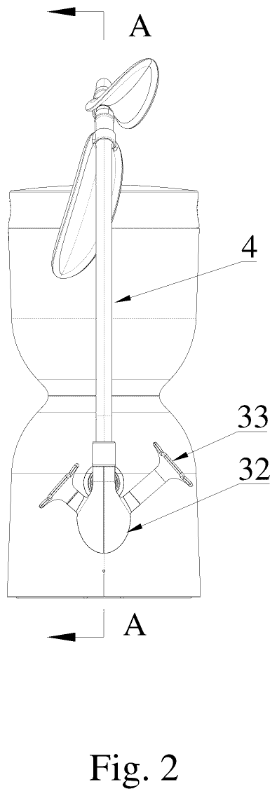

In the suck component 3 of the present embodiment, the suck component 3 is also provided with an suck port 31, and the suck port 31 is made of a flexible material, which may communicate with the above-mentioned water storing bladder 32, and the suck component 3 may not be provided with a duckbill valve 34, which may specifically limit the diameter of the suck port 31, that is, the suck port 31 is provided with an suck slit of a pre-set size, which may also prevent ants and bees as well as allowing extension of the beak of a hummingbird into the water storing bladder 32 normally to suck the sugar water. In addition, as shown in FIGS. 1 and 2, simulated leaves are further provided on the above-mentioned extension component 4 of the suck component 3, and the simulated leaf may contain chemical materials for driving ants, or the whole extension component 4, and the suck component 3 contain chemical materials for driving ants; and the chemical materials for repelling ants may be specifically capsaicin and aromatic hydrocarbons selected for use.

Further, as may be seen referring to the structural cross-sectional view shown in FIG. 3, at least a portion of the water tank 53 may extend into the equipment compartment of the body 5 for mounting the camera 1, the battery, and other controllers when actually provided for the reason that: the electronic components in an equipment compartment of the body will emit heat when actually working, the water tank 53 is probed into the equipment compartment, and the heat in the equipment compartment may be effectively delivered to the sugar water in the water tank 53, which may not only effectively prevent the overheat problem caused by the long-time working of a camera 1 and improve the security of the equipment, but also effectively heat the sugar water to ensure that the hummingbird may still normally takes the sugar water in cold weather.

It is obvious that in some other embodiments, in order to heat the sugar water, the body 5 is further provided with a heating assembly for heating the sugar water in the water tank 53. For example, an electric heating part such as an electric heating wire may be mounted on an outer circumferential wall of the water tank 53 to heat the sugar water in the form of electric heating. The body 5 is further provided with a sugar quality monitoring assembly for monitoring the quality of the sugar water in the water tank 53, understanding the quality of the sugar water, and reminding the user to replace the sugar water when it deteriorates so as to ensure the health of the hummingbird. When the sugar water deteriorates, the electrical parameters such as capacitance, resistance and density of the sugar water will change, and the sugar quality monitoring assembly may specifically acquire and monitor the electrical parameters and density of the sugar water to monitor the quality of the sugar water.

In addition, as shown in FIG. 1, in the present embodiment, in order to facilitate the mounting of the body 5, a mounting frame 7 may be provided, which may be mounted and fixed in a suitable position in particular by a fastener such as a bolt, and the mounting frame 7 may be provided with a mounting position, and a magnetic component may be provided at the bottom of the body 5 of the hummingbird shooting system so as to be detachably provided at the mounting position directly using a magnetic attraction principle, which may greatly simplify the mounting and detaching process of a user, and the user may easily detach the body 5 of the hummingbird shooting system from the mounting frame 7 and perform periodic inspection and export shooting data.

### Embodiment 2

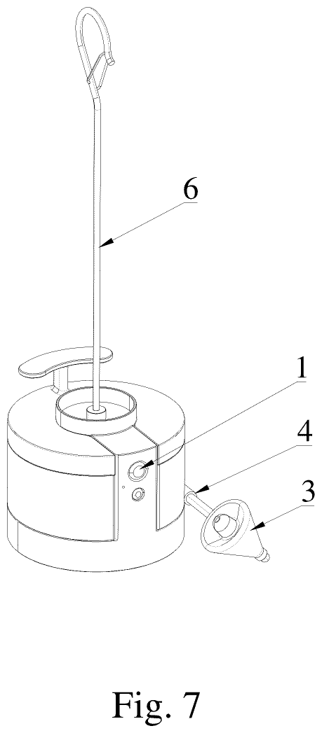

As shown in FIGS. 7 to 9, in the second embodiment, the hummingbird shooting system of the present application specifically includes a body 5, a single camera 1, and a single feeding assembly 2 including an suck component 3 and an extension component 4 having one end connected to the suck component 3 and the other end connected to the middle portion of the body 5. The top end of the above-mentioned body 5 may be correspondingly provided with a hook 6, so as to facilitate a user to provide the hook in an appropriate position for mounting and placement.

As shown in FIG. 7, in the present embodiment, the above-mentioned camera 1 is specifically provided on the body 5, and the camera 1 may be provided corresponding to the suck component 3 of the above-mentioned feeding assembly 2, so as to capture an image of the hummingbird in a pre-set area according to shooting requirements when the hummingbird is taking sugar water; and the image of the hummingbird includes at least one of a hummingbird, the suck component 3 corresponding to the feeding assembly 2, and the extension component 4.

It should be noted that in the present embodiment, as shown in FIG. 9, the body 5 is provided with a water tank 53, which is detachably provided in the middle portion of the body 5 to facilitate cleaning and adding sugar water. The other end of the extension component 4 is connected to a side bottom end of the water tank 53. In the present embodiment, the water tank 53 is an annular water tank, and may be sleeved in the middle portion of the body 5. The extension component 4 is provided with a water delivering passage 41 for communicating the water tank 53 and the suck component 3 via the water delivering passage 41. The suck component 3 is provided with a water storing bladder 32, and the above-mentioned water delivering passage 41 communicates with a water tank 53 and a water storing bladder 32 of the suck component 3. In order to prevent the sugar water from overflowing, the maximum level of the water tank 53 is not higher than the maximum level in the suck component 3.

Further, in the present embodiment, the body 5 is provided with a water outlet control assembly which drives the water in the water tank 53 to be delivered from the middle portion of the body 5 to the water storing bladder 32 through the water delivering passage 41 based on the communicating vessel principle, so that the water level in the water tank 53 is the same as the water level in the water storing bladder 32 of the suck component 3.

### Embodiment 3

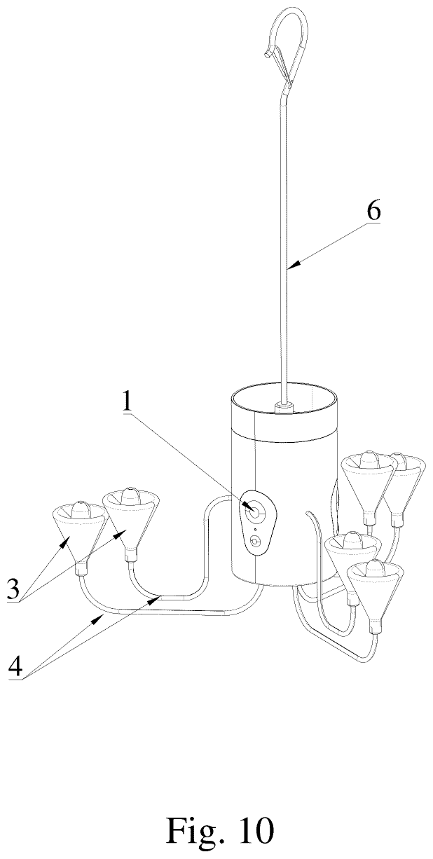

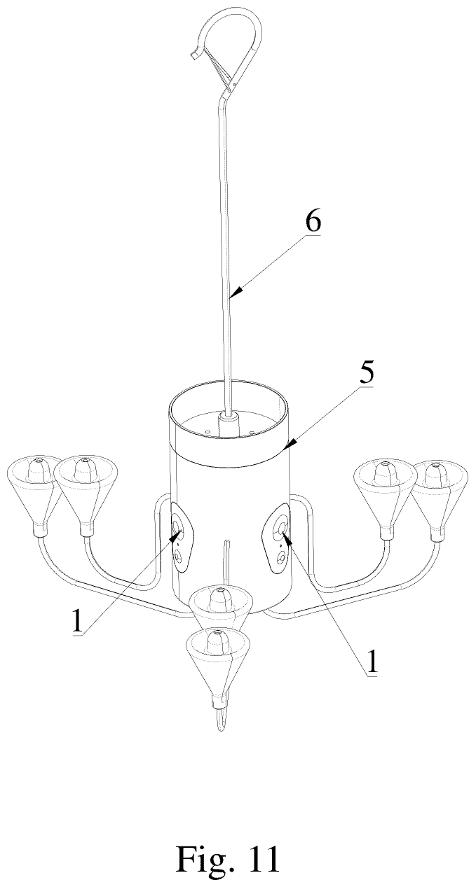

As shown in FIGS. 10-11, in the third embodiment, the hummingbird shooting system of the present application specifically includes a body 5, three cameras 1 and six feeding assemblies 2, where the feeding assemblies 2 include an suck component 3 and an extension component 4; where one respective end of the extension components 4 of the three feeding assemblies 2 is connected to the suck component 3, and the other respective end is connected to the bottom end of the body 5; the extension components 4 of the other three feeding assemblies 2 are connected at one end to the suck component 3 and at the other end to the middle portion of the body 5. The top end of the above-mentioned body 5 may be correspondingly provided with a hook 6, so as to facilitate a user to provide the hook in an appropriate position for mounting and placement.

As shown in FIGS. 10 and 11, in the present embodiment, three cameras 1 are provided on the body 5, and the three cameras 1 are respectively provided corresponding to the suck components 3 of the two feeding assemblies 2 so as to respectively capture images of hummingbirds in a pre-set area; where the image of the hummingbird includes at least one of a hummingbird, the suck component 3 corresponding to two feeding assemblies 2, and the extension component 4.

In practice, the image of the hummingbird captured by the above-mentioned three cameras 1 may be clipped and spliced, and an image of the hummingbird may be captured at 360 degrees in at least one dimension to obtain a panoramic image of the hummingbird. Since each camera 1 is provided corresponding to two feeding assemblies 2, it may also obtain and output a close-up photograph of the hummingbird corresponding to the location of the two feeding assemblies 2.

It should be noted that in the present embodiment, the body 5 is provided with a water tank 53, and the extension component 4 is provided with a water delivering passage 41 so as to communicate the water tank 53 and the suck component 3 via the above-mentioned water delivering passage 41; where the suck component 3 is provided with a water storing bladder 32, and the above-mentioned water delivering passage 41 may correspond to the water storing bladder 32 communicating with the water tank 53 and the suck component 3. In order to prevent the sugar water from overflowing, the maximum level of the water tank 53 is not higher than the maximum level in the suck component 3.

In addition, in the present embodiment, the body 5 is provided with a water outlet control assembly which drives the water in the water tank 53 to be delivered from the bottom end of the body 5 or the middle portion of the body 5 to the water storing bladder 32 of the corresponding suck component 3 through the water delivering passage 41 in each extension component 4 based on the communicating vessel principle, and the water level in the water tank 53 is the same as that in the respective water storing bladder 32 of the suck components 3 of all feeding assemblies 2.

### Embodiment 4

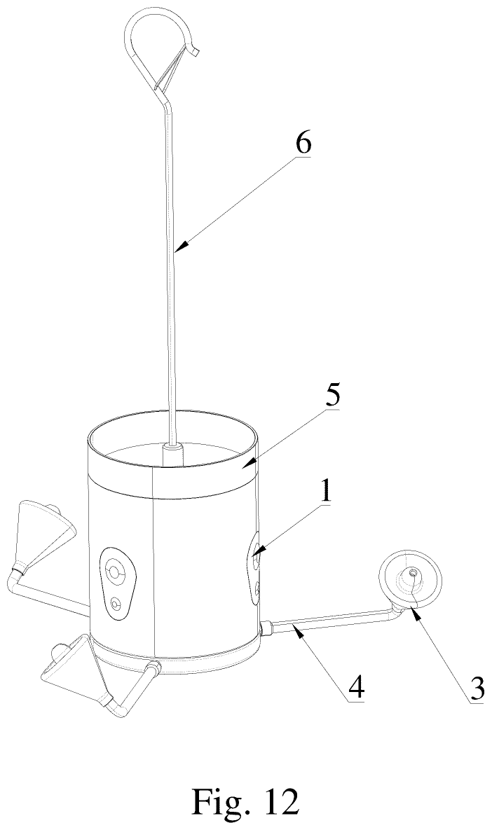

As shown in FIG. 12, in the fourth embodiment, the hummingbird shooting system of the present application specifically includes a body 5, three cameras 1 and three feeding assemblies 2, the feeding assemblies 2 including an suck component 3 and an extension component 4, the extension component 4 having one end connected to the suck component 3 and the other end connected to the bottom end of the body 5. The top end of the above-mentioned body 5 may be correspondingly provided with a hook 6, so as to facilitate a user to provide the hook in an appropriate position for mounting and placement.

As shown in FIG. 12, in the present embodiment, three cameras 1 are provided on the body 5, and the three cameras 1 are respectively provided corresponding to the suck components 3 of one feeding assembly 2 so as to respectively capture images of hummingbirds in a pre-set area; where the image of the hummingbird includes at least one of a hummingbird, the suck component 3 corresponding to the feeding assembly 2, and the extension component 4.

In practice, the image of the hummingbird captured by the above-mentioned three cameras 1 may be clipped and spliced, and an image of the hummingbird may be captured at 360 degrees in at least one dimension to obtain a panoramic image of the hummingbird. Since each camera 1 is provided corresponding to a single feeding assembly 2, it may also obtain and output a close-up photograph of the hummingbird corresponding to the location of the single feeding assembly 2.

It should be noted that in the present embodiment, the body 5 is provided with a water tank 53, and the extension component 4 is provided with a water delivering passage 41 so as to communicate the water tank 53 and the suck component 3 via the above-mentioned water delivering passage 41; where the suck component 3 is provided with a water storing bladder 32, and the above-mentioned water delivering passage 41 communicates the water storing bladder 32 with the water tank 53 and the suck component 3.

In the present embodiment, the body 5 is provided with a water outlet control assembly which drives the water in the water tank 53 to be delivered from the bottom end of the body 5 to the water storing bladder 32 through the water delivering passage 41 based on the communicating vessel principle, and the water level in the water tank 53 is the same as the water level in the water storing bladder 32 of the suck component 3.

### Example 5

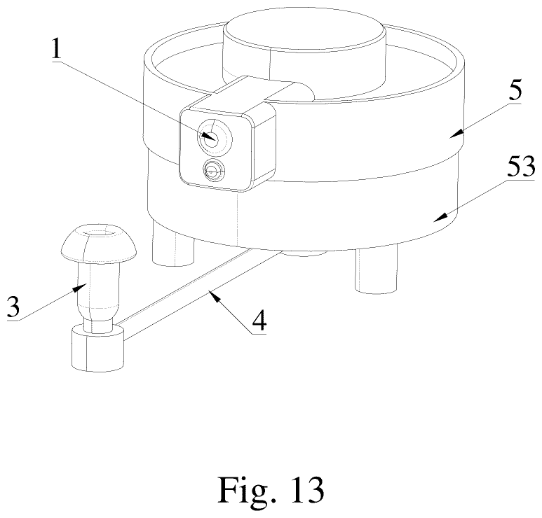

As shown in FIG. 13, in the fifth embodiment, the structure is similar to that of the second embodiment described above, but the structure of the body 5 of fifth embodiment is different from that of the second embodiment. In the fifth embodiment, the hummingbird shooting system of the present application specifically includes a body 5, a water tank 53, a single camera 1 and a single feeding assembly 2, where the feeding assembly 2 includes an suck component 3 and an extension component 4, and the water tank 53 is detachably assembled at the bottom end of the body 5 to facilitate cleaning and adding sugar water. The extension component 4 has one end connected to the suck component 3 and the other end connected to the bottom end of the water tank 53. The bottom end of the above-mentioned water tank 53 is provided with feet so as to provide support via the feet. In addition, in order to prevent the sugar water in the water tank 53 from overflowing, the maximum water level in the suck component 3 is not lower than that of the water tank 53, and further, the maximum water level of the suck component 3 is equal to that of the water tank 53.

As shown in FIG. 13, in the present embodiment, the above-mentioned camera 1 is specifically provided on the body 5, and the camera 1 may be provided corresponding to the suck component 3 of the above-mentioned feeding assembly 2, so as to capture an image of the hummingbird in a pre-set area according to shooting requirements when the hummingbird is taking sugar water; and the image of the hummingbird includes at least one of a hummingbird, the suck component 3 corresponding to the feeding assembly 2, and the extension component 4.

It may be seen from the above description that the beneficial effects of the present application are as follows: the hummingbird shooting system of the present application may be effectively used for a home user or a bird research center, and may replace manual observation and shoot and record when a hummingbird is taking the sugar water; at the same time, after an extension component 4 is used to extend the above-mentioned suck component 3 for the hummingbird to take the sugar water to a designated shooting position opposite to the camera 1, the camera 1 may ensure that there is no artificial structure other than the feeding assembly 2 and the hummingbird in a pre-set area for shooting, so as to perfectly simulate a real scene where the hummingbird is taking nectar in nature, which has a good promotion prospect and application value.

The above-mentioned embodiments are merely examples of the present application and are not intended to limit the scope of the present application, and all changes which come within the meaning and range of equivalence of the present application and the appended claims are to be embraced within their scope.

1. A hummingbird shooting system, comprising: a feeding assembly and a camera, the feeding assembly comprising an suck component and an extension component, the suck component being used for suck of a hummingbird, the extension component being connected to the suck component, and the extension component being used for extending the suck component to a designated shooting position opposite to the camera for the camera to capture an image of the hummingbird in a pre-set area according to shooting requirements when the hummingbird is sucking sugar water; wherein the image of the hummingbird comprises: at least one of the hummingbird, the suck component, and the extension component.

2. The hummingbird shooting system according to claim 1, wherein the image of the hummingbird comprises a hummingbird but excludes the suck component and the extension component;
or the image of the hummingbird comprises at least part of the suck component and the hummingbird but excludes the extension component;
or the image of the hummingbird comprises at least part of the suck component, at least part of the extension component and the hummingbird.

3. The hummingbird shooting system according to claim 1, wherein the suck component is provided with at least one suck port for the hummingbird's suck of the sugar water through the suck port;
the suck component is provided with a water storing bladder, and the suck port communicates with the water storing bladder;
the water storing bladder independently stores water;
or the water storing bladder is connected to a water tank, and the water tank supplies the sugar water.

4. The hummingbird shooting system according to claim 3, wherein the suck component further comprises a flower simulating component, and the flower simulating component is connected to an edge of the suck port.

5. The hummingbird shooting system according to claim 1, wherein the extension component has one end connected to the suck component and has the other end connected to the ground or another mounting position.

6. The hummingbird shooting system according to claim 1, further comprising a body, the extension component having one end connected to the suck component and the other end connected to the body; wherein the other end of the extension component is connected to at least one of a top end, a bottom end and a middle portion of the body;
the camera is provided on or around the body.

7. The hummingbird shooting system according to claim 6, wherein the body is provided with a water tank, and the extension component is provided with a water delivering passage;
the water delivering passage communicates with the water tank and the suck component; or the suck component is provided with a water storing bladder, and the water delivering passage communicates with the water tank and the water storing bladder.

8. The hummingbird shooting system according to claim 7, wherein the other end of the extension component is connected to the top end of the body, the water delivering passage communicates with the water tank from the top end of the body, and the water tank supplies the sugar water to the water delivering passage from the top end of the body.

9. The hummingbird shooting system according to claim 8, wherein the body siphons the sugar water in the water tank to the suck component via the water delivering passage.

10. The hummingbird shooting system according to claim 9, wherein the body comprises a lower housing and an upper cover body, the upper cover body and the lower housing together forming a water storing chamber of the water tank; when a downward pressure is applied to the upper cover body, the upper cover body is pressed and sealedly cooperates the lower housing and compresses the water storing chamber space to achieve siphoning.

11. The hummingbird shooting system according to claim 10, wherein the upper cover body comprises an outer cover body, an inner cover body and an air chamber tube, the outer cover body is rotatably covered on the top end of the inner cover body, the top end of the air chamber tube is connected to the inner cover body, and the bottom end can be placed inside the water storing chamber; the other end of the extension component passes through the upper cover body from the top end of the body, extends into the air chamber tube and extends out of the bottom end of the air chamber tube; a venting passage is provided in the upper cover body and used for communicating the air chamber tube with the outside, and the venting passage is closed when the outer cover body is in the first position; the venting passage is conductive when the outer cover body rotates relative to the inner cover body and is in the second position.

12. The hummingbird shooting system according to claim 11, wherein the outer cover body is rotatably covered on the top end of the inner cover body and detachably assembled with the lower housing, and the top end periphery of the inner cover body is sealedly assembled with the lower housing.

13. The hummingbird shooting system according to claim 11, wherein a communication hole is provided at the top of the inner cover body, the communication hole correspondingly communicates with the air chamber tube, and a sealing gasket is provided on a peripheral wall of the communication hole; one end of the outer cover body corresponding to the inner cover body is provided with an annular protrusion, and the annular protrusion is provided corresponding to the communication hole and is sealable by the sealing gasket when the outer cover body is in the first position.

14. The hummingbird shooting system according to claim 13, wherein an internal venting port is provided on the annular protrusion, an external venting port is provided on an outer wall of the outer cover body, and a conduction passage between the external venting port and the internal venting port is the venting passage; when the outer cover body is in the first position, the sealing gasket seals the internal venting port, the external venting port, the internal venting port and the communication hole are non-conductive, and when the outer cover body rotates to a second position, the sealing gasket does not seal the internal venting port, and the external venting port, the internal venting port and the communication hole are conductive.

15. The hummingbird shooting system according to claim 14, wherein the sealing gasket is provided with a recessed portion, and a thickness of a gasket of the recessed portion is smaller than a thickness of a respective gasket of other parts; when the outer cover body is in the first position, the internal venting port is sealed by other parts of the sealing gasket, and when the outer cover body rotates to the second position, the internal venting port correspondingly rotates to the recessed portion, and the internal venting port is conductive to the communication hole.

16. The hummingbird shooting system according to claim 11, wherein when the upper cover body is in the second position, a port at which the extension component extends into one end of the suck component is not higher than a bottom end of the air chamber tube, or the suck component is provided with a water storing bladder, and a port at which the extension component extends into one end of the water storing bladder is not higher than a bottom end of the air chamber tube.

17. The hummingbird shooting system according to claim 7, wherein at least a portion of the water tank extends into an equipment compartment of the body, and the body is further provided with a heating assembly for heating the sugar water in the water tank.

18. The hummingbird shooting system according to claim 7, wherein the body is further provided with a capacity monitoring assembly for monitoring the capacity of the sugar water in the water tank.

19. The hummingbird shooting system according to claim 7, wherein the body is further provided with a sugar quality monitoring assembly for monitoring quality of the sugar water in the water tank.

20. The hummingbird shooting system according to claim 7, wherein the other end of the extension component is connected to the bottom end of the body, the water delivering passage communicates with the water tank from the bottom end of the body, and the water tank supplies the sugar water to the water delivering passage from the bottom end of the body;
or the other end of the extension component is connected to the middle portion of the body, the water delivering passage communicates with the water tank from the middle portion of the body, and the water tank supplies the sugar water to the water delivering passage from the middle portion of the body.

21. The hummingbird shooting system according to claim 20, wherein the body delivers water in the water tank to the suck component through the water delivering passage based on a communicating vessel principle, and a water level in the water tank is the same as that in the suck component;
or the suck component is provided with a water storing bladder, and the body delivers water in the water tank to the water storing bladder through the water delivering passage based on the communicating vessel principle, and the water level in the water tank is the same as that in the water storing bladder.

22. The hummingbird shooting system according to claim 20, wherein the water tank is detachably mounted at a bottom end of the body, and the other end of the extension component is connected to the bottom end of the water tank;
or the water tank is detachably sleeved in the middle portion of the body, and the other end of the extension component is connected to a side bottom end of the water tank.

23. The hummingbird shooting system according to claim 7, wherein an electric water feeding mechanism is provided in the body and the electric water feeding mechanism comprises a controller and a driving component, wherein the controller is electrically connected to the driving component, and the driving component is used for receiving a start command sent by the controller and driving the water in the water tank to be delivered to the suck component or the water storing bladder via the water delivering passage.

24. The hummingbird shooting system according to claim 1, wherein the plurality of suck components are connected to the same extension component; a single camera is provided corresponding to one feeding assembly, or a single camera is provided corresponding to the plurality of feeding assemblies.

25. The hummingbird shooting system according to claim 1, wherein the camera captures an image of the hummingbird at 360 degrees in at least one dimension.
